(19) United States
(12) Patent Application Publication
(10) Pub. No.: US 2025/0356342 A1
(43) Pub. Date: Nov. 20, 2025

(54) ENTITY TOKEN SEGREGATION

(71) Applicant: Coinbase, Inc., Oakland, CA (US)

(72) Inventors: Siyu Liu, Palo Alto, CA (US); Hao Mao, Kirkland, WA (US); Jun Hui Erh, San Francisco, CA (US); Wei You, Hillsborough, CA (US); Akash Shah, Millbrae, CA (US); Maliena Guy, La Jolla, CA (US); Luca Bonmassar, Tiburon, CA (US)

(21) Appl. No.: 18/667,991

(22) Filed: May 17, 2024

(51) Int. Cl. G06Q 20/36; G06Q 20/38

(52) U.S. Cl. CPC G06Q 20/367; G06Q 20/3829; G06Q 20/389

(57) ABSTRACT

Methods, systems, and devices for entity token segregation are described. A custodial token platform (e.g., via a ledger service or manager) monitors a set of actions by a first set of user profiles at a custodial token platform based on the first set of user profiles being associated with a first segregated entity for which a rebalancing rule is configured. The custodial token platform determines, based on the rebalancing rule, a net change in token amounts attributed to the first set of user profiles associated with the first segregated entity during a first duration of time. The custodial token platform executes a transfer of a first amount of one or more crypto tokens between a first blockchain address associated with the first segregated entity and a second blockchain address associated with the custodial token platform, where the first amount is based on the rebalancing rule and the net change.

### FIELD OF TECHNOLOGY

The present disclosure relates generally to data management, including techniques for entity token segregation.

### BACKGROUND

Blockchains and related technologies may be employed to support recordation of ownership of digital assets, such as cryptocurrencies, fungible tokens, non-fungible tokens (NFTs), and the like. Generally, peer-to-peer networks support transaction validation and recordation of transfer of such digital assets on blockchains. Various types of consensus mechanisms may be implemented by the peer-to-peer networks to confirm transactions and to add blocks of transactions to the blockchain networks. Example consensus mechanisms include the proof-of-work consensus mechanism implemented by the Bitcoin network and the proof-of-stake mechanism implemented by the Ethereum network. Some nodes of a blockchain network may be associated with a digital asset exchange, which may be accessed by users to trade digital assets or trade a fiat currency for a digital asset.

### BRIEF DESCRIPTION OF THE DRAWINGS

FIG. 1 illustrates an example of a computing environment that supports entity token segregation in accordance with aspects of the present disclosure.

FIG. 2 shows an example of a process flow that supports entity token segregation in accordance with aspects of the present disclosure.

FIG. 3 shows an example of a compliance calculation table that supports entity token segregation in accordance with aspects of the present disclosure.

FIG. 4 shows an example of a process flow that supports entity token segregation in accordance with aspects of the present disclosure.

FIG. 5 shows a block diagram of an apparatus that supports entity token segregation in accordance with aspects of the present disclosure.

FIG. 6 shows a block diagram of a rebalancing application that supports entity token segregation in accordance with aspects of the present disclosure.

FIG. 7 shows a diagram of a system including a device that supports entity token segregation in accordance with aspects of the present disclosure.

FIGS. 8 and 9 show flowcharts illustrating methods that support entity token segregation in accordance with aspects of the present disclosure.

### DETAILED DESCRIPTION

The use of cryptocurrency in transactions in various industries in various geographic locations has increased. The cryptocurrency balances for the various users may be aggregated and stored or associated with a single wallet, such as one or more wallets managed by a custodial token platform. In some cases, the balances may be segregated by client or entity. However, some geographic locations or entities, such as countries or a group of countries, may be associated with one or more regulations that specify rules for the cryptocurrency balance that may be stored in a non-dedicated wallet, such as the wallet with aggregated balances for users across multiple geographic locations. For example, regulations may include maintaining a threshold balance in a dedicated wallet for all users in a particular geographic location. Accordingly, the aggregated balances in the single wallet for users from multiple geographic locations may not comply with the regulations.

Techniques described herein address these difficulties by supporting segregated wallets based on geographic locations. The technique involves rebalancing a dedicated wallet associated with a geographic location based on one or more trigger events (e.g., when to rebalance) indicating that the dedicated wallet is not in compliance with a regulation for the geographic location. For example, rebalancing may involve transferring cryptocurrency from the aggregated wallet with commingled assets of users from multiple geographic locations (e.g., Canada, Europe, United States, etc.) to the segregated or dedicated wallet for the geographic location (e.g., dedicated Canada wallet). The trigger events may include thresholds, such as an aggregated balance associated with users in the geographic location being below a threshold balance (e.g., 80% of aggregated funds associated with Canadian users are not in Canada wallet or a wallet with a Canadian agency).

For example, a custodial token platform (e.g., via a ledger service or manager) may monitor a set of actions by a first set of user profiles (e.g., Canada users) at a custodial token platform based on the first set of user profiles being associated with a first segregated entity (e.g., Canada) for which a rebalancing rule is configured. The custodial token platform may determine, based on the rebalancing rule, a net change in token amounts attributed to the first set of user profiles associated with the first segregated entity during a first duration of time (e.g., threshold time). The custodial token platform may execute a transfer of a first amount of one or more crypto tokens between a first blockchain address associated with the first segregated entity and a second blockchain address associated with the custodial token platform (e.g., transfer to wallet associated with Canadian users), where the first amount is based on the rebalancing rule and the net change. These and other techniques are described in further detail with respect to the figures. Although the discussions discussed herein describe segregating wallets based on geographic locations, the techniques discussed herein may apply to any regulations. For example, the aggregated balances wallet may be segregated based on a regulation that is not associated with a geographic location (e.g., group of users associated with a non-geographic commonality) but rather other types of entities (e.g., organizations, companies, agencies, associations).

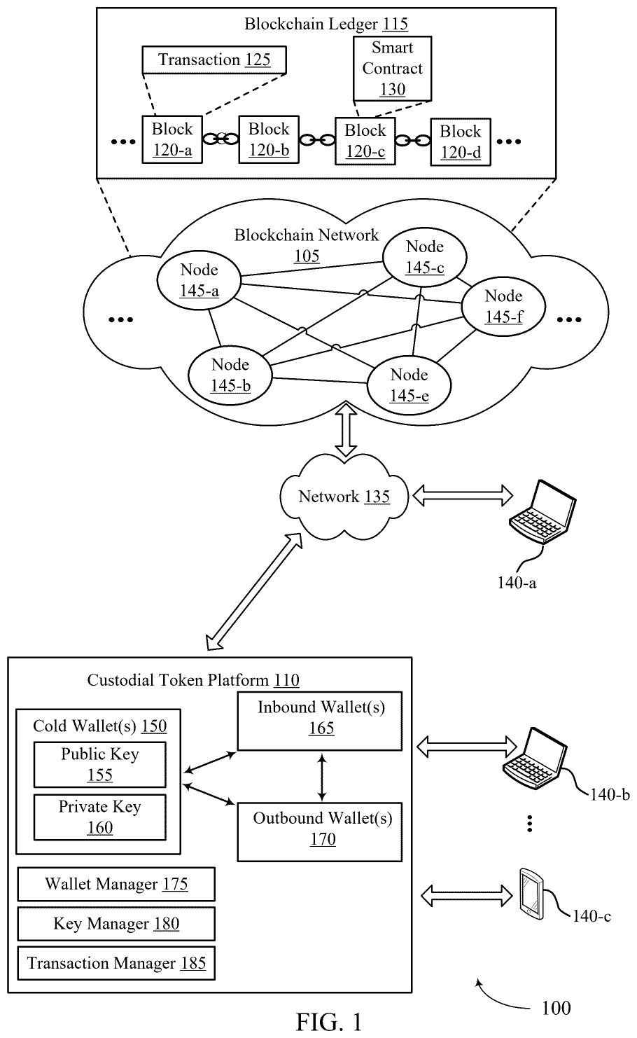

FIG. 1 illustrates an example of a computing environment 100 that supports entity token segregation in accordance with aspects of the present disclosure. The computing environment 100 may include a blockchain network 105 that supports a blockchain ledger 115, a custodial token platform 110, and one or more computing devices 140, which may be in communication with one another via a network 135.

The network 135 may allow the one or more computing devices 140, one or more nodes 145 of the blockchain network 105, and the custodial token platform 110 to communicate (e.g., exchange information) with one another. The network 135 may include aspects of one or more wired networks (e.g., the Internet), one or more wireless networks (e.g., cellular networks), or any combination thereof. The network 135 may include aspects of one or more public networks or private networks, as well as secured or unsecured networks, or any combination thereof. The network 135 also may include any quantity of communications links and any quantity of hubs, bridges, routers, switches, ports or other physical or logical network components.

Nodes 145 of the blockchain network 105 may generate, store, process, verify, or otherwise use data of the blockchain ledger 115. The nodes 145 of the blockchain network 105 may represent or be examples of computing systems or devices that implement or execute a blockchain application or program for peer-to-peer transaction and program execution. For example, the nodes 145 of the blockchain network 105 support recording of ownership of digital assets, such as cryptocurrencies, fungible tokens, non-fungible tokens (NFTs), and the like, and changes in ownership of the digital assets. The digital assets may be referred to as tokens, coins, crypto tokens, or the like. The nodes 145 may implement one or more types of consensus mechanisms to confirm transactions and to add blocks (e.g., blocks 120-a, 120-b, 120-c, and so forth) of transactions (or other data) to the blockchain ledger 115. Example consensus mechanisms include a proof-of-work consensus mechanism implemented by the Bitcoin network and a proof-of-stake consensus mechanism implemented by the Ethereum network.

When a device (e.g., the computing device 140-a, 140-b, or 140-c) associated with the blockchain network 105 executes or completes a transaction associated with a token supported by the blockchain ledger, the nodes 145 of the blockchain network 105 may execute a transfer instruction that broadcasts the transaction (e.g., data associated with the transaction) to the other nodes 145 of the blockchain network 105, which may execute the blockchain application to verify the transaction and add the transaction to a new block (e.g., the block 120-d) of a blockchain ledger (e.g., the blockchain ledger 115) of transactions after verification of the transaction. Using the implemented consensus mechanism, each node 145 may function to support maintaining an accurate blockchain ledger 115 and prevent fraudulent transactions.

The blockchain ledger 115 may include a record of each transaction (e.g., a transaction 125) between wallets (e.g., wallet addresses) associated with the blockchain network 105. Some blockchains may support smart contracts, such as smart contract 130, which may be an example of a sub-program that may be deployed to the blockchain and executed when one or more conditions defined in the smart contract 130 are satisfied. For example, the nodes 145 of the blockchain network 105 may execute one or more instructions of the smart contract 130 after a method or instruction defined in the smart contract 130 is called by another device. In some examples, the blockchain ledger 115 is referred to as a blockchain distributed data store.

A computing device 140 may be used to input information to or receive information from the computing system custodial token platform 110, the blockchain network 105, or both. For example, a user of the computing device 140-a may provide user inputs via the computing device 140-a, which may result in commands, data, or any combination thereof being communicated via the network 135 to the computing system custodial token platform 110, the blockchain network 105, or both. Additionally, or alternatively, a computing device 140-a may output (e.g., display) data or other information received from the custodial token platform 110, the blockchain network 105, or both. A user of a computing device 140-a may, for example, use the computing device 140-a to interact with one or more user interfaces (e.g., graphical user interfaces (GUIs)) to operate or otherwise interact with the custodial token platform 110, the blockchain network 105, or both.

A computing device 140 and/or a node 145 may be a stationary device (e.g., a desktop computer or access point) or a mobile device (e.g., a laptop computer, tablet computer, or cellular phone). In some examples, a computing device 140 and/or a node 145 may be a commercial computing device, such as a server or collection of servers. And in some examples, a computing device 140 and/or a node 145 may be a virtual device (e.g., a virtual machine).

Some blockchain protocols support layer one and layer two crypto tokens. A layer one token is a token that is supported by its own blockchain protocol, meaning that the layer one token (or a derivative thereof), may be used to pay transaction fees for transacting using the blockchain protocol. A layer two token is a token that is built on top of layer one, for example, using a smart contract 130 or a decentralized application (“Dapp”). The smart contract 130 or decentralized application may issue layer two tokens to various users based on various conditions, and the users may transact using the layer two tokens, but transaction fees may be based on the layer one token (or a derivative thereof).

The custodial token platform 110 may support exchange or trading of digital assets, fiat currencies, or both by users of the custodial token platform 110. The custodial token platform 110 may be accessed via website, web application, or applications that are installed on the one or more computing devices 140. The custodial token platform 110 may be configured to interact with one or more types of blockchain networks, such as the blockchain network 105, to support digital asset purchase, exchange, deposit, and withdrawal.

For example, users may create accounts associated with the custodial token platform 110 such as to support purchasing of a digital asset via a fiat currency, selling of a digital asset via fiat currency, or exchanging or trading of digital assets. A key management service (e.g., a key manager) of the custodial token platform 110 may create, manage, or otherwise use private keys that are associated with user wallets and internal wallets. For example, if a user wishes to withdraw a token associated with the user account to an external wallet address, key manager 180 may sign a transaction associated with a wallet of the user, and broadcast the signed transaction to nodes 145 of the blockchain network 105, as described herein. In some examples, a user does not have direct access to a private key associated with a wallet or account supported or managed by the custodial token platform 110. As such, user wallets of the custodial token platform 110 may be referred to non-custodial wallets or non-custodial addresses.

The custodial token platform 110 may create, manage, delete, or otherwise use various types of wallets to support digital asset exchange. For example, the custodial token platform 110 may maintain one or more internal cold wallets 150. The internal cold wallets 150 may be an example of an offline wallet, meaning that the cold wallet 150 is not directly coupled with other computing systems or the network 135 (e.g., at all times). The cold wallet 150 may be used by the custodial token platform 110 to ensure that the custodial token platform 110 is secure from losing assets via hacks or other types of unauthorized access and to ensure that the custodial token platform 110 has enough assets to cover any potential liabilities. The one or more cold wallets 150, as well as other wallets of the blockchain network 105 may be implemented using public key cryptography, such that the cold wallet 150 is associated with a public key 155 and a private key 160. The public key 155 may be used to publicly transact via the cold wallet 150, meaning that another wallet may enter the public key 155 into a transaction such as to move assets from the wallet to the cold wallet 150. The private key 160 may be used to verify (e.g., digitally sign) transactions that are transmitted from the cold wallet 150, and the digital signature may be used by nodes 145 to verify or authenticate the transaction. Other wallets of the custodial token platform 110 and/or the blockchain network 105 may similarly use aspects of public key cryptography.

The custodial token platform 110 may also create, manage, delete, or otherwise use inbound wallets 165 and outbound wallets 170. For example, a wallet manager 175 of the custodial token platform 110 may create a new inbound wallet 165 for each user or account of the custodial token platform 110 or for each inbound transaction (e.g., deposit transaction) for the custodial token platform 110. In some examples, the custodial token platform 110 may implement techniques to move digital assets between wallets of the digital asset exchange platform. Assets may be moved based on a schedule, based on asset thresholds, liquidity requirements, or a combination thereof. In some examples, movements or exchanges of assets internally to the custodial token platform 110 may be “off-chain” meaning that the transactions associated with the movement of the digital asset are not broadcast via the corresponding blockchain network (e.g., blockchain network 105). In such cases, the custodial token platform 110 may maintain an internal accounting (e.g., ledger) of assets that are associated with the various wallets and/or user accounts.

As used herein, a wallet, such as inbound wallets 165 and outbound wallets 170 may be associated with a wallet address, which may be an example of a public key, as described herein. The wallets may be associated with a private key that is used to sign transactions and messages associated with the wallet. A wallet may also be associated with various user interface components and functionality. For example, some wallets may be associated with or leverage functionality for transmitting crypto tokens by allowing a user to enter a transaction amount, a receiver address, etc. into a user interface and clicking or activating a UI component such that the transaction is broadcast via the corresponding blockchain network via a node (e.g., a node 145) associated with the wallet. As used herein, “wallet” and “address” may be used interchangeably.

In some cases, the custodial token platform 110 may implement a transaction manager 185 that supports monitoring of one or more blockchains, such as the blockchain ledger 115, for incoming transactions associated with addresses managed by the custodial token platform 110 and creating and broadcasting on-blockchain transactions when a user or customer sends a digital asset (e.g., a withdrawal). For example, the transaction manager 185 may monitor the addressees of the customers for transfer of layer one or layer two tokens supported by the blockchain ledger 115 to the addresses managed by the custodial token platform 110. As another example, when a user is withdrawing a digital asset, such as a layer one or layer two token, to an external wallet (e.g., an address that is not managed by the custodial token platform 110 or an address for which the custodial token platform 110 does not have access to the associated private key), the transaction manager 185 may create and broadcast the transaction to one or more other nodes 145 of the blockchain network 105 in accordance with the blockchain application associated with the blockchain network 105. As such, the transaction manager 185, or an associated component of the custodial token platform 110 may function as a node 145 of the blockchain network 105.

As described herein, the custodial token platform may implement and support various wallets including the inbound wallets 165, the outbound wallets 170, and the cold wallets 150. Further, the custodial token platform 110 may implement techniques to maintain and manage balances of the various wallets. In some examples, the balances of the various wallets are configured to support security and liquidity. For example, the custodial token platform 110 may implement transactions that move crypto tokens between the inbound wallets 165 and the outbound wallets 170. These transactions may be referred to as “flush” transactions and may occur on a periodic or scheduled basis.

As described herein, various transactions may be broadcast to the blockchain ledger 115 to cause transfer of crypto tokens, to call smart contracts, to deploy smart contracts etc. In some examples, these transactions may also be referred to as messages. That is, the custodial token platform 110 may broadcast a message to the blockchain network 105 to cause transfer of tokens between wallets managed by the custodial token platform 110 to an external wallet, to deploy a smart contract (e.g., a self-executing program), or to call a smart contract.

Additionally, users may access various applications and marketplaces to buy, sell, create, trade, and otherwise transact with blockchain addresses. In some cases, users may engage in certain activity, such as fraudulent or malicious activity. As governments or entities may associate cryptocurrency use with fraudulent activity, some entities have implemented rules or regulations regarding the management of cryptocurrency. In some cases, an exchange (e.g., custodial token platform 110) that has custody (e.g., based on private key management) of many users' funds may be required to maintain a threshold balance of funds within a wallet that has agency with the specific entity. For example, Canada (e.g., an entity) may require that 80% of funds associated with Canadian users be managed by or attributed to a wallet with a Canadian agency (e.g., managed by a administer(s) within Canada). However, some exchanges may associate all users (across various entities) with one or more wallets without attribution to wallets associated with specific entities. Additionally, separating wallets based on entities may require significant processor and resource overhead as documentation of user locations or residency is required. In some examples, exchanges may not maintain or document where users are located or where users reside. Moreover, maintaining large balances to support liquidity requirements over multiple entities is computationally complex.

As discussed herein, the custodial token platform 110 may implement a service or a standalone service may support a scalable technique for segregating on-platform funds based on a geographic location into a segregated wallet associated with the geographic location (or other entity type), as well as rebalancing funds based on regulations associated with the geographic location. The technique may involve the custodial token platform 110 (e.g., via a ledger service or manager) monitoring a set of actions by a first set of user profiles (e.g., Canada users) at the custodial token platform 110 based on the first set of user profiles being associated with a first segregated entity (e.g., Canada) for which a rebalancing rule is configured. The custodial token platform 110 may determine, based on the rebalancing rule, a net change in token amounts attributed to the first set of user profiles associated with the first segregated entity during a first duration of time (e.g., threshold time, periodic or aperiodic time and/or based on a trigger event). The custodial token platform 110 may execute a transfer of a first amount of one or more crypto tokens between a first blockchain address associated with the first segregated entity (e.g., segregated wallet for Canada) and a second blockchain address associated with the custodial token platform (e.g., aggregated wallet with crypto tokens for all users from various geographic locations). The first amount may be based on the rebalancing rule and the net change. These and other techniques are described in further detail with respect to the figures. Although the discussions discussed herein describe segregating wallets based on geographic locations, the techniques discussed herein may apply to any regulations, rules, conditions, or requirements. For example, the aggregated crypto token balances in the single wallet (e.g., or associated with a single wallet address) may be segregated based on a regulation that is not associated with a geographic location (e.g., group of users associated with a non-geographic commonality). The centralized ledger service that segregates and rebalances wallets may facilitate crypto currency wallet compliance with regulations associated with geographic locations.

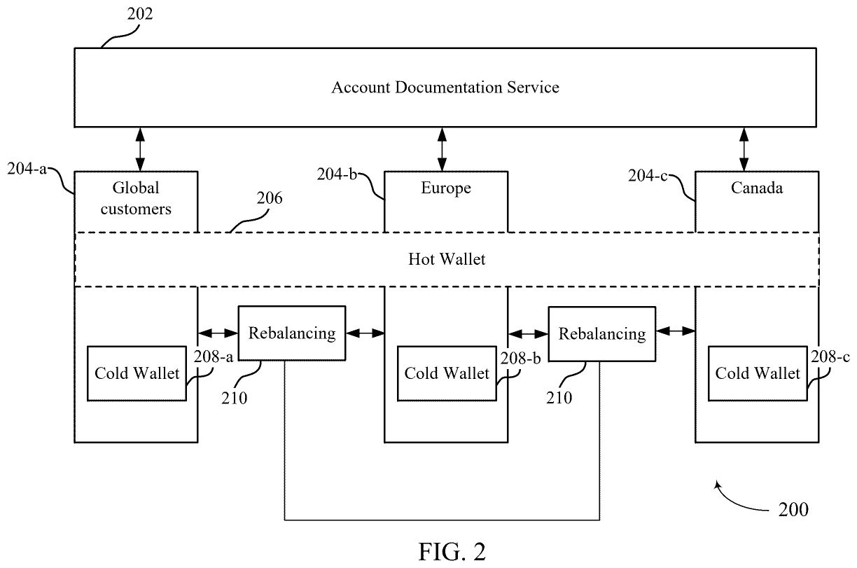

FIG. 2 shows an example of a process flow 200 that supports entity token segregation in accordance with aspects of the present disclosure. The process flow 200 may include an account documentation service 202 (e.g., associated with the custodial token platform) that communicates with or manages a first segregated entity 204-a associated with the global customers (e.g., global users from multiple geographic locations, such as users from the United States, Europe, and/or Canada)), a second segregated entity 204-b associated with Europe (e.g., European Union (EU)), and a third segregated entity 204-c associated with Canada.

Each of the segregated entities 204 may be associated with a cold wallet 208. For example, the first segregated entity 204-a associated with the global customers may include a first cold wallet 208-a. The second segregated entity 204-b associated with Europe may include a second cold wallet 208-b. The third segregated entity 204-c associated with Canada may include a third cold wallet 208-c.

The account documentation service 202 may communicate with each of the segregated entities 204 and orchestrate a rebalancing 210 between the cold wallets 208 of the segregated entities 204 based on a trigger, such as noncompliance with a regulation for at least one of the segregated entities 204 and/or based on a time threshold. For example, in some examples, the rebalancing 210 may include transferring crypto currency between the first cold wallet 208-a and the third cold wallet 208-c (e.g., global to Canada). The transfer of cryptocurrency between the cold wallets 208 may be a direct transfer between the cold wallets 208 or via a hot wallet 206 (e.g., first cold wallet 208-a to the hot wallet 206 and the hot wallet 206 to the third cold wallet 208-c). The hot wallet 206 may be an example of or represent one or more wallets that provide liquidity for various types of actions performed by the user and/or by other entities on the exchange. For example, the hot wallet 206 may facilitate buying, selling, and exchanging cryptocurrencies on the exchange and may provide liquidity for such actions. Hot wallets, such as hot wallet 206, may be generated based on liquidity and/or user needs. Additionally, each segregated entity 204 may be associated with a respective hot wallet (or multiple hot wallets), or the hot wallets may be shared across segregated entities 204, as illustrated in FIG. 2.

As part of the segregating and rebalancing, the account documentation service 202 may segregate across all products (e.g., an exchange, a management service, an investment service) associated with the custodial token platform. The account documentation service 202 may track each transaction associated with each of the users of each of the global and geographic locations to calculate inventory and withholding of the products at each of the segregated entities 204. The account documentation service 202 may periodically automatically calculate balances and perform rebalancing to provide downstream crypto currency wallet orchestration and facilitate moving assets (e.g., funds) between wallets (e.g., cold wallets). In some examples, the account documentation service 202 may perform a daily or scheduled rebalancing. The account documentation service 202 may monitor and set alerts (e.g., triggers), such as setting thresholds and monitoring assets for rebalancing.

The account documentation service 202 may aggregate multiple transaction types across multiple assets for multiple products (e.g., consumer, exchange, and prime), and move assets on-chain and through rebalancing. The rebalancing may minimize on-chain crypto movement gas costs and increase efficiency. Aggregating multiple transaction types may include transactions, such as buying (e.g., credit), selling (e.g., debit), send (debit) and/or receive (e.g., credit), crypto-to-crypto (C2C) trading (e.g., converting), withdrawal crypto (e.g., debit), staking (e.g., credit), earning (e.g., credit), layer two network transactions, and the like. The asset types may include, without limitation, Bitcoin (BTC), ETH (Ethereum), Uniswap (UNI), Litecoin (LTC), Flow (FLOW), Compound (COMP).

Segregating and rebalancing may facilitate a scalable platform solution that enables the custodial token platform to facilitate (e.g., via the account documentation service 202) regulation compliance, adoption of new or changing regulations, efficient orchestration that minimizes on-chain transfer costs through ledger-based (e.g., account documentation service 202) segregation for all transactions across all products. The account documentation service 202 or another service may provide a real time dashboard for visibility for the users. As an example of rebalancing, the following table 1 indicates a rebalancing by transferring 2 BTC to compensate for the loss of 2 BTC (−2 BTC) after calculating the net value (−2 BTC) at the global aggregated wallets.

TABLE 1

| | Global wallet | Segregated EU wallet |
|---|---|---|
| EU Customer A | −5 BTC | |
| (withdrawal) | | |
| EU Customer B | +4 BTC | |
| (receive) | | |
| EU customer C | −3 BTC | |
| (buy) | | |
| EU customer D | +2 BTC | |
| (sell) | | |
| Net Value | −2 BTC | |
| Rebalancing | +2 BTC | −2 BTC |

In this example, multiple EU customers having a balance in the global wallet may buy and sell assets, resulting in a net value that may be out of compliance. For example, EU customer A withdraws 5 BTC (e.g., −5 BTC), EU customer B receives 4 BTC (e.g., +4 BTC), EU customer C buys assets using 3 BTC (e.g., −3 BTC), and customer D sells 2 BTC (e.g., +2 BTC). The account documentation service 202 may rebalance the 2 BTC from the EU wallet to the global wallet (e.g., cold wallet to cold wallet) (e.g., or vice versa).

In this example, a hot wallet of the global wallet may provide buying and selling liquidity, and the account documentation service 202 may aggregate all buy and/or sell transactions and calculate a net value (e.g., −2 BTC at the global wallet). The on-chain rebalancing may include moving 2 BTC to the global wallet when settling the transactions during a subsequent rebalancing. The account documentation service 202 (e.g., ledger) may aggregate all the buying transactions and the selling transactions for EU customers across all assets within a time threshold, and the rebalancing of the net value between global wallet and the segregated EU wallet. By balancing the on-chain liquidity, the account documentation service 202 may manage regulatory requirements.

As another example, an entity, such as Canada, may require that 80% of user funds (e.g., cryptocurrency held by user accounts converted to fiat amounts based on current exchange rates) be held within the cold wallet 208-c with Canadian agency. In such cases, the account documentation service 202 may maintain satisfaction of the threshold by monitoring, within a time period (where the start of the time period satisfies the threshold), transactions users that are in Canada. The account documentation service 202 may determine a net change (converted to fiat) within the time period, and automatically rebalance between the global wallet (e.g., the cold wallet 208-a) and the cold wallet 208-c by broadcasting transactions via the blockchain network based on the net change.

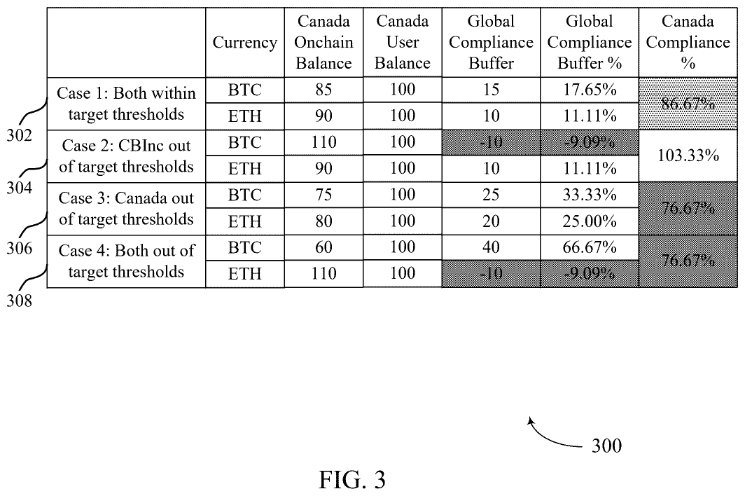

FIG. 3 shows an example of a compliance calculation table 300 that supports entity token segregation in accordance with aspects of the present disclosure. The compliance calculation table 300 includes a first compliance case 302, a second compliance case 304, a third compliance case 306, and a fourth compliance case 308. As discussed herein, calculations may lead to rebalancing. The rebalancing may be based on one or more triggers, such as a periodic rebalancing trigger or a manual rebalancing trigger. The periodic rebalancing trigger may include a rebalancing based on a scheduler, such as based on an interval time (e.g., daily basis). The manual rebalancing may include manual triggers for rebalancing that may be configured and reconfigured.

The compliance calculation table 300 may be based on Canadian users and balances. Canadian user funds may be held in the custodial token platform (e.g., in a wallet) and tracked in a ledger (e.g., account documentation service 202 of FIG. 2). The Canadian user funds held in the custodial token platform and/or tracked by the ledger may be referred to as Canada entity user funds from ledger (Canada User Balance). The compliance calculation table 300 may include on-chain wallet balances holding Canadian funds (Canada Onchain Balance).

For compliance calculations, the Canadian compliance regulation may include that 80% of Canadian user crypto currency is held within the Canada Onchain balance (e.g., within one or more wallets with Canadian agency). The 80% may be calculated as the fiat equivalent for all crypto currencies based on current exchange rates. Since the Canada User Balance and the Canada Onchain Balance are both aggregated, the Canadian compliance calculation may include aggregating all balances for the Canada Onchain Balance and the Canada User Balance (e.g., crypto currencies in Fiat), and calculating if the quotient of the Canada User Balance and the Canada Onchain Balance is greater than 0.80. (e.g., [Canada Onchain Balance/Canada User Balance]>0.80).

In the compliance calculation table 300, and as an example, the BTC may be equivalent or converted to $2 and the ETH may be equivalent to or converted to $1. The Global Compliance buffer may be calculated by the difference between the Global Compliance Buffer and the Canada User Balance, and calculating if the difference is greater than 0 (e.g., [Canada User Balance−the Global Compliance Buffer]>0). The Canada Onchain Balance compliance may be calculated by the sum of assets in Canada converted to fiat (e.g., calculating the quotient of the Canada Onchain Balance and the Canada User Balance [Canada Onchain Balance/Canada User Balance]).

Based on performing these calculations for each of the cases for each of the ETH and the BTC, in first compliance case 302 (Case 1), the Global Compliance of 17.65% for BTC, the Global Compliance of 11.11% for ETH, and the Canada Compliance of 86.67% are within respective thresholds, and thus compliant. For example, both the Global Compliance for BTC and ETH are greater than 0 and the Canada Compliance is greater than 0.80. In some examples, when the balance is near noncompliance, the compliance may be visually indicated in the table 300 as being nearly noncompliant (e.g., indicated by a shading in the current example).

In second compliance case 304 (Case 2), the Global Compliance of −9.09% for BTC is not within the respective threshold (e.g., greater than 0), and thus, is noncompliant. The Global Compliance of 11.11% for ETH is within the respective threshold (e.g., greater than 0), and thus, is the Global Compliance of −9.09% for BTC is not within the respective threshold (e.g., greater than 0), and thus, is noncompliant. The Canada Compliance of 103.33% is greater than the threshold of 0.8 and is compliant. In some examples, when the balance is noncompliant, the noncompliance may be visually indicated in the table 300 as being noncompliant (e.g., indicated by a shading that is relatively darker than the nearly noncompliant shading in the current example).

In third compliance case 306 (Case 3), the Global Compliance of 33.33% for BTC and the Global Compliance of 25.00% for ETH are within respective thresholds (e.g., greater than 0), and thus compliant. However, the Canada Compliance of 76.67% is less than the threshold of 0.8 and thus, is noncompliant.

In the fourth compliance case 308 (Case 4), the Global Compliance of 66.67% for BTC is within the respective threshold (e.g., greater than 0) and is compliant. However, the Global Compliance of −9.09% for ETH is less than the respective threshold (e.g., less than 0) and is noncompliant. The Canada Compliance of 76.67% is less than the threshold of 0.8 and thus, is noncompliant.

In some examples, rebalancing thresholds for the Canada Onchain Balance and the Global Compliance Buffer include a percentage of user balances held the Canada Onchain Balance that may trigger rebalancing, overall rebalancing range, and target percentages after rebalancing. For example, the threshold for holding users for the Global Compliance includes balances 1:1 for individual crypto currencies for Global wallet user balances. The Canada threshold may be 80% of holdings of all crypto in Canadian user balances to be in the Canada Onchain Balance.

The thresholds described herein may facilitate rebalancing to move funds to target the given thresholds. Rebalancing from Canada Onchain Balance to Global Compliance may be performed on a per asset-basis. Each asset may be checked for rebalancing, for example, as described with respect to the cases 302, 304, 306, and 308. Rebalancing from the Global Compliance buffer to Canada Onchain Balance may be based on an aggregated quantity, but may still move each asset individually.

As another example, for each asset, the Canada Onchain Balance may not hold more than 96% of user balances and assets may be moved from the Canada Onchain Balance to the Global Compliance Buffer to target the 93%. For the aggregated fiat amount of all balances, the rebalancing may involve determining that at least 81% of all Canadian user balances are in the Canada Onchain Balance. Any lower values may involve moving assets from Global Compliance Buffer to Canada Onchain Balance (e.g., moving assets between wallets using blockchain transactions). In some examples, rebalancing the Canada Onchain Balance may involve prioritizing higher value assets (e.g., move BTC, ETH, etc., based on a priority order). In some examples, if BTC is moved from the Canada Onchain Balance to the Global Compliance Buffer to satisfy thresholds for the Global Compliance Buffer, rebalancing may not move Global Compliance Buffer BTC balances back to Canada Onchain Balance. Also, if an asset in Canada Onchain Balance exceeds 100% of user balances, this asset may not be used for rebalancing.

Rebalancing may include multiple concurrent pool transfers, such that each pool transfer does not have to be completed before starting a new one. The concurrent pool transfers may improve overall entity balance tracking and compliance, since the rebalancing system may need to change rebalancing requests based on user fund movements. In some examples, the multiple concurrent pool transfers may occur if they are in the same direction, such as a transfer of funds from the Global Compliance Buffer to the Canada Onchain Balance. In some examples, a single cryptocurrency may be present in a single or default network, or the crypto currency may be on multiple networks onchain. In some examples, detection and monitoring may involve dashboards indicating aggregated portfolio of assets and trendlines of assets over time (e.g., with respect to the threshold). The detection and monitoring may also include alerting or paging when outside of target thresholds (e.g., alert Canada Compliance when outside of target on of Canada Onchain Balance threshold, alert custodial token platform when Global Compliance Buffer is outside of target on threshold.

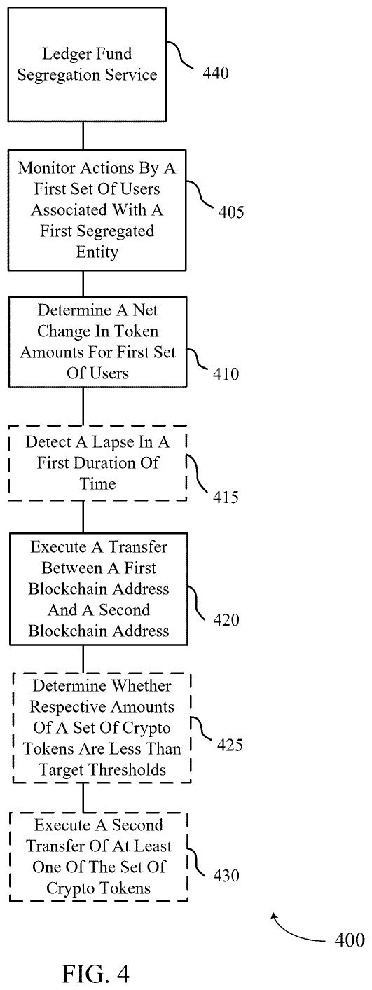

FIG. 4 shows an example of a process flow 400 that supports entity token segregation in accordance with aspects of the present disclosure. The process flow 400 includes an entity token segregation service 440 (e.g., segregates wallets and rebalance crypto currency balance), which may be an example of service as described with respect to FIGS. 1 through 3. In some examples, the entity token segregation service 440 may be supported by a custodial token platform 110 of FIG. 1. In the following description of the process flow 400, the operations performed by the custodial token platform (e.g., custodial token platform 110-a of FIG. 1) may be transmitted in a different order than the example order shown, or the operations performed may be performed in different orders or at different times. Some operations may also be omitted from the process flow 400, and other operations may be added to the process flow 400.

At 405, the entity token segregation service 440 may monitor a set of actions by a first set of user profiles at a custodial token platform based on the first set of user profiles being associated with a first segregated entity (e.g., Canada) for which a rebalancing rule is configured. The rebalancing rule may specify that a threshold percentage of an aggregated token amount attributed to the first set of user profiles associated with the first segregated entity is to be held by the first blockchain address associated with the first segregated entity. The rebalancing rule may further specify that a second aggregated token amount attributed to a second set of user profiles associated with a second segregated entity is to be held by the second blockchain address that is associated with the second segregated entity. In some examples, the first segregated entity includes an entity associated with a geographic location (e.g., United States, Canada, EU, etc.)

At 410, the entity token segregation service 440 may determine, based on the rebalancing rule, a net change in token amounts attributed to the first set of user profiles associated with the first segregated entity during a first duration of time. In some examples, determining the net change further includes determining, using the set of actions, a respective net change for each crypto token of a set of crypto tokens supported by the custodial token platform, and combining the respective net changes for the plurality of crypto tokens.

In some examples, determining the net change further includes combining amounts associated with one or more of a set of action types of the set of actions associated with the first set of user profiles. The set of action types may include buying, selling, sending, receiving, converting, withdrawing, staking, earning, layer two network messages, or any combination thereof. In some examples, at 415, the entity token segregation service 440 may detect a lapse in the first duration of time, where the net change is determined based on detecting the lapse in the first duration of time.

At 420, the entity token segregation service 440 may execute a transfer of a first amount of one or more crypto tokens between a first blockchain address associated with the first segregated entity and a second blockchain address associated with the custodial token platform (e.g., global wallet), where the first amount is based on the rebalancing rule and the net change. In some examples, executing the transfer between the first blockchain address and the second blockchain address includes, executing the transfer between the first blockchain address associated with one or more first private keys stored in a first offline environment and the second blockchain address that is associated with one or more second private keys stored in a second offline environment. Additionally, executing a transfer may include broadcasting one or more transactions or messages via one or more blockchain networks to cause transfer of one or more cryptocurrencies or crypto tokens.

In some examples, executing the transfer between the first blockchain address and the second blockchain address includes executing a first transfer between the first blockchain address associated with one or more first private keys stored in a first offline environment and a third blockchain address associated with one or more third private keys stored in a first online environment, and executing a second transfer between the third blockchain address and the second blockchain address that is associated with one or more second private keys stored in a second offline environment.

In some examples, at 425, the entity token segregation service 440 may determine that the second transfer results in an aggregated token amount attributed to the first set of user profiles being out of compliance with the rebalancing rule. In some examples, at 430, the entity token segregation service 440 may execute a third transfer of at least one other crypto token of the set of crypto tokens between the first blockchain address and the second blockchain address.

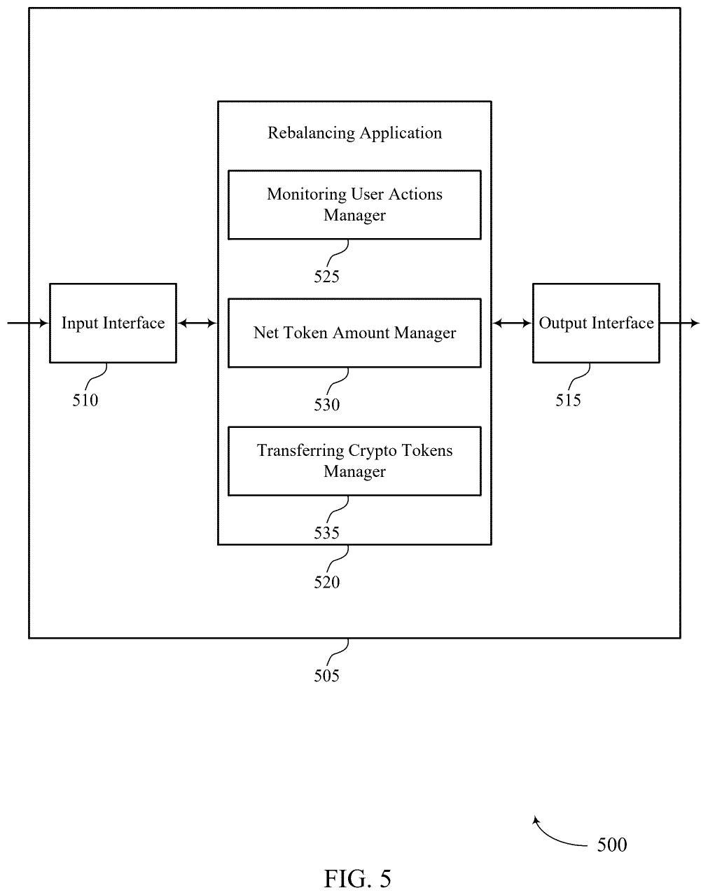

FIG. 5 shows a block diagram 500 of a system 505 that supports entity token segregation in accordance with aspects of the present disclosure. The system 505 may include an input interface 510, an output interface 515, and a rebalancing application 520. The system 505, or one or more components of the system 505 (e.g., the input interface 510, the output interface 515, the rebalancing application 520), may include at least one processor, which may be coupled with at least one memory, to support the described techniques. Each of these components may communicate, directly or indirectly, with one another (e.g., via one or more buses, communications links, communications interfaces, or any combination thereof).

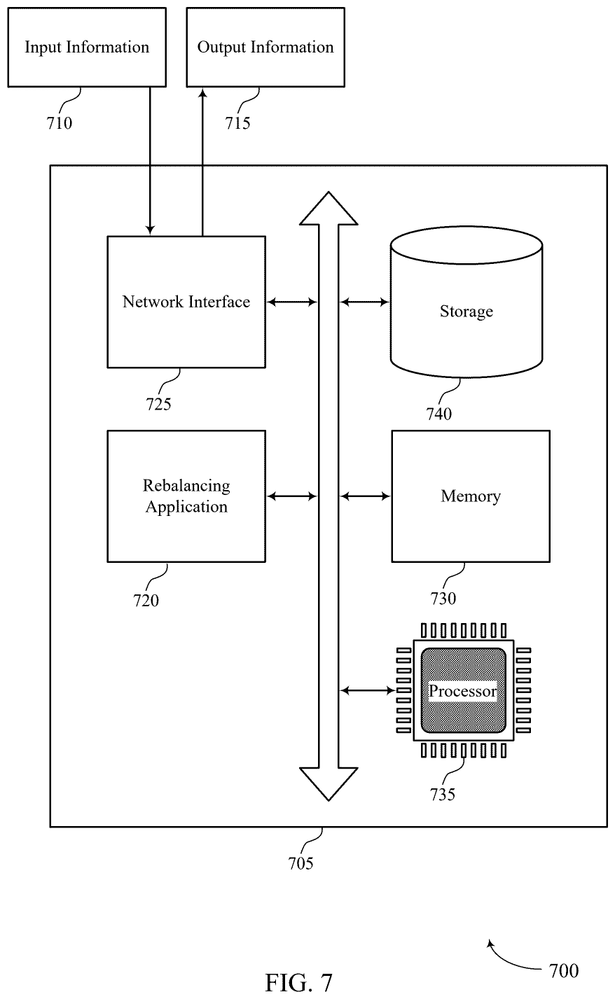

The input interface 510 may manage input signaling for the system 505. For example, the input interface 510 may receive input signaling (e.g., messages, packets, data, instructions, commands, transactions, or any other form of encoded information) from other systems or devices. The input interface 510 may send signaling corresponding to (e.g., representative of or otherwise based on) such input signaling to other components of the system 505 for processing. For example, the input interface 510 may transmit such corresponding signaling to the rebalancing application 520 to support entity token segregation. In some cases, the input interface 510 may be a component of a network interface 725 as described with reference to FIG. 7.

The output interface 515 may manage output signaling for the system 505. For example, the output interface 515 may receive signaling from other components of the system 505, such as the rebalancing application 520, and may transmit such output signaling corresponding to (e.g., representative of or otherwise based on) such signaling to other systems or devices. In some cases, the output interface 515 may be a component of a network interface 725 as described with reference to FIG. 7.

For example, the rebalancing application 520 may include a monitoring user actions manager 525, a net token amount manager 530, a transferring crypto tokens manager 535, or any combination thereof. In some examples, the rebalancing application 520, or various components thereof, may be configured to perform various operations (e.g., receiving, monitoring, transmitting) using or otherwise in cooperation with the input interface 510, the output interface 515, or both. For example, the rebalancing application 520 may receive information from the input interface 510, send information to the output interface 515, or be integrated in combination with the input interface 510, the output interface 515, or both to receive information, transmit information, or perform various other operations as described herein.

The rebalancing application 520 may support segregating blockchain address actions in accordance with examples as disclosed herein. The monitoring user actions manager 525 may be configured as or otherwise support a means for monitoring a plurality of actions by a first plurality of user profiles at a custodial token platform based at least in part on the first plurality of user profiles being associated with a first segregated entity for which a rebalancing rule is configured. The net token amount manager 530 may be configured as or otherwise support a means for determining, based at least in part on the rebalancing rule, a net change in token amounts attributed to the first plurality of user profiles associated with the first segregated entity during a first duration of time. The transferring crypto tokens manager 535 may be configured as or otherwise support a means for executing a transfer of a first amount of one or more crypto tokens between a first blockchain address associated with the first segregated entity and a second blockchain address associated with the custodial token platform, wherein the first amount is based at least in part on the rebalancing rule and the net change.

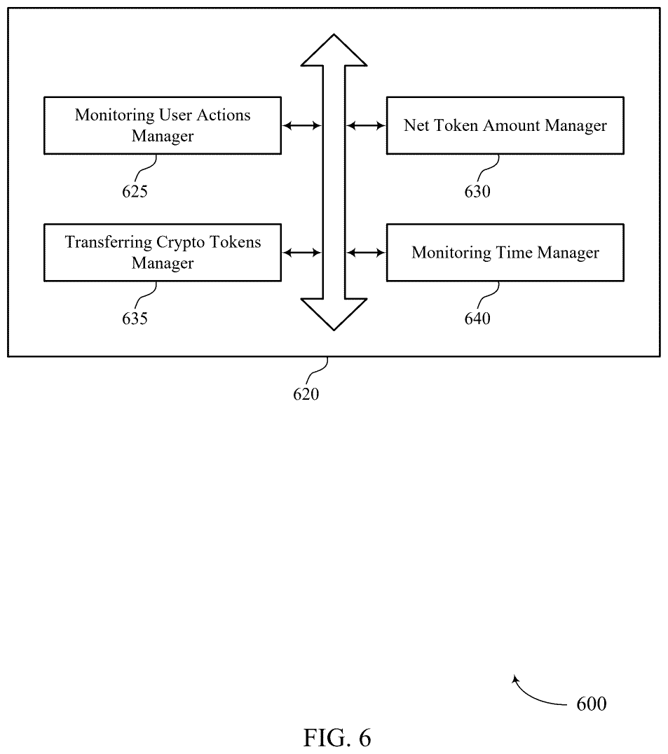

FIG. 6 shows a block diagram 600 of a rebalancing application 620 that supports entity token segregation in accordance with aspects of the present disclosure. The rebalancing application 620 may be an example of aspects of a rebalancing application or a rebalancing application 520, or both, as described herein. The rebalancing application 620, or various components thereof, may be an example of means for performing various aspects of entity token segregation as described herein. For example, the rebalancing application 620 may include a monitoring user actions manager 625, a net token amount manager 630, a transferring crypto tokens manager 635, a monitoring time manager 640, or any combination thereof. Each of these components may communicate, directly or indirectly, with one another (e.g., via one or more buses, communications links, communications interfaces, or any combination thereof).

The rebalancing application 620 may support segregating blockchain address actions in accordance with examples as disclosed herein. The monitoring user actions manager 625 may be configured as or otherwise support a means for monitoring a plurality of actions by a first plurality of user profiles at a custodial token platform based at least in part on the first plurality of user profiles being associated with a first segregated entity for which a rebalancing rule is configured. The net token amount manager 630 may be configured as or otherwise support a means for determining, based at least in part on the rebalancing rule, a net change in token amounts attributed to the first plurality of user profiles associated with the first segregated entity during a first duration of time. The transferring crypto tokens manager 635 may be configured as or otherwise support a means for executing a transfer of a first amount of one or more crypto tokens between a first blockchain address associated with the first segregated entity and a second blockchain address associated with the custodial token platform, wherein the first amount is based at least in part on the rebalancing rule and the net change.

In some examples, the rebalancing rule specifies that a threshold percentage of an aggregated token amount attributed to the first plurality of user profiles associated with the first segregated entity is to be held by the first blockchain address associated with the first segregated entity.

In some examples, the rebalancing rule further specifies that a second aggregated token amount attributed to a second plurality of user profiles associated with a second segregated entity is to be held by the second blockchain address that is associated with the second segregated entity.

In some examples, the monitoring time manager 640 may be configured as or otherwise support a means for detecting a lapse in the first duration of time, wherein the net change is determined based at least in part on detecting the lapse in the first duration of time.

In some examples, the first segregated entity comprises an entity associated with a geographic location.

In some examples, to support executing the transfer between the first blockchain address and the second blockchain address, the transferring crypto tokens manager 635 may be configured as or otherwise support a means for executing the transfer between the first blockchain address associated with one or more first private keys stored in a first offline environment and the second blockchain address that is associated with one or more second private keys stored in a second offline environment.

In some examples, to support executing the transfer between the first blockchain address and the second blockchain address, the transferring crypto tokens manager 635 may be configured as or otherwise support a means for executing a first transfer between the first blockchain address associated with one or more first private keys stored in a first offline environment and a third blockchain address associated with one or more third private keys stored in a first online environment. In some examples, to support executing the transfer between the first blockchain address and the second blockchain address, the transferring crypto tokens manager 635 may be configured as or otherwise support a means for executing a second transfer between the third blockchain address and the second blockchain address that is associated with one or more second private keys stored in a second offline environment.

In some examples, to support determining the net change, the net token amount manager 630 may be configured as or otherwise support a means for determining, using the plurality of actions, a respective net change for each crypto token of a plurality of crypto tokens supported by the custodial token platform. In some examples, to support determining the net change, the net token amount manager 630 may be configured as or otherwise support a means for combining the respective net changes for the plurality of crypto tokens.

In some examples, to support determining the net change, the net token amount manager 630 may be configured as or otherwise support a means for combining amounts associated with one or more of a plurality of action types of the plurality of actions associated with the first plurality of user profiles.

In some examples, the plurality of action types comprises buying, selling, sending, receiving, converting, withdrawing, staking, earning, layer two network messages, or any combination thereof.

In some examples, the net token amount manager 630 may be configured as or otherwise support a means for determining whether respective amounts of a set of crypto tokens associated with the first plurality of user profiles are less than one or more target thresholds associated with the first segregated entity. In some examples, the transferring crypto tokens manager 635 may be configured as or otherwise support a means for executing a second transfer of at least one of the set of crypto tokens.

In some examples, the transferring crypto tokens manager 635 may be configured as or otherwise support a means for determining that the second transfer results in an aggregated token amount attributed to the first plurality of user profiles being out of compliance with the rebalancing rule. In some examples, the transferring crypto tokens manager 635 may be configured as or otherwise support a means for executing a third transfer of at least one other crypto token of the set of crypto tokens between the first blockchain address and the second blockchain address.

FIG. 7 shows a diagram of a system 700 including a system 705 that supports entity token segregation in accordance with aspects of the present disclosure. The system 705 may be an example of or include components of a system 505 as described herein. The system 705 may include components for bi-directional voice and data communications including components for transmitting and receiving communications, such as a rebalancing application 720, an input information 710, an output information 715, a network interface 725, at least one memory 730, at least one processor 735, and a storage 740. Each of these components may communicate, directly or indirectly, with one another (e.g., via one or more buses, communications links, communications interfaces, or any combination thereof).

The network interface 725 may enable the system 705 to exchange information (e.g., input information 710, output information 715, or both) with other systems or devices (not shown). For example, the network interface 725 may enable the system 705 to connect to a network (e.g., a network 135 as described herein). The network interface 725 may include one or more wireless network interfaces, one or more wired network interfaces, or any combination thereof.

Memory 730 may include RAM, ROM, or both. The memory 730 may store computer-readable, computer-executable software including instructions that, when executed, cause at least one processor 735 to perform various functions described herein, such as functions supporting entity token segregation. In some cases, the memory 730 may contain, among other things, a basic input/output system (BIOS), which may control basic hardware or software operation such as the interaction with peripheral components or devices. In some cases, the memory 730 may be an example of aspects of one or more components of a custodial token platform 110 as described with reference to FIG. 1. The memory 730 may be an example of a single memory or multiple memories. For example, the system 705 may include one or more memories 730.

The processor 735 may include an intelligent hardware device, (e.g., a general-purpose processor, a DSP, a CPU, a microcontroller, an ASIC, a field programmable gate array (FPGA), a programmable logic device, a discrete gate or transistor logic component, a discrete hardware component, or any combination thereof). The processor 735 may be configured to execute computer-readable instructions stored in at least one memory 730 to perform various functions (e.g., functions or tasks supporting entity token segregation). Though a single processor 735 is depicted in the example of FIG. 7, it is to be understood that the system 705 may include any quantity of one or more of processors 735 and that a group of processors 735 may collectively perform one or more functions ascribed herein to a processor, such as the processor 735. The processor 735 may be an example of a single processor or multiple processors. For example, the system 705 may include one or more processors 735.

Storage 740 may be configured to store data that is generated, processed, stored, or otherwise used by the system 705. In some cases, the storage 740 may include one or more HDDs, one or more SDDs, or both. In some examples, the storage 740 may be an example of a single database, a distributed database, multiple distributed databases, a data store, a data lake, or an emergency backup database. In some examples, the storage 740 may be an example of one or more components described with reference to FIG. 1.

The rebalancing application 720 may support segregating blockchain address actions in accordance with examples as disclosed herein. For example, the rebalancing application 720 may be configured as or otherwise support a means for monitoring a plurality of actions by a first plurality of user profiles at a custodial token platform based at least in part on the first plurality of user profiles being associated with a first segregated entity for which a rebalancing rule is configured. The rebalancing application 720 may be configured as or otherwise support a means for determining, based at least in part on the rebalancing rule, a net change in token amounts attributed to the first plurality of user profiles associated with the first segregated entity during a first duration of time. The rebalancing application 720 may be configured as or otherwise support a means for executing a transfer of a first amount of one or more crypto tokens between a first blockchain address associated with the first segregated entity and a second blockchain address associated with the custodial token platform, wherein the first amount is based at least in part on the rebalancing rule and the net change.

By including or configuring the rebalancing application 720 in accordance with examples as described herein, the system 705 may support techniques for ensuring crypto currency compliance with regulations associated with geographic locations.

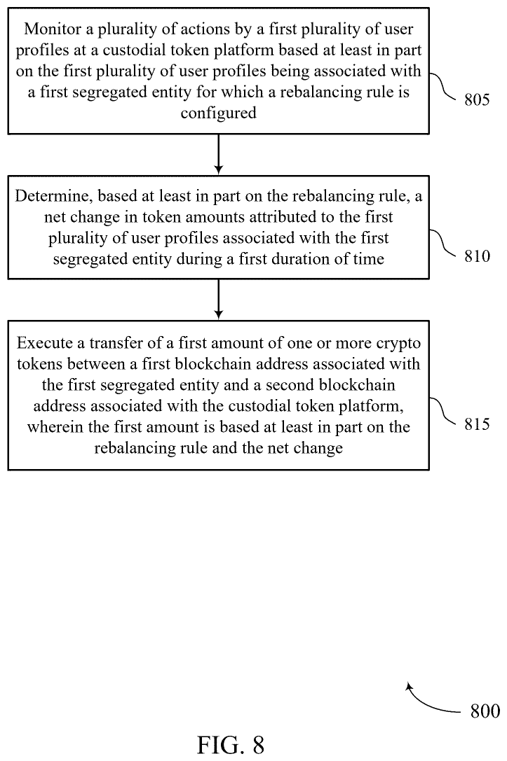

FIG. 8 shows a flowchart illustrating a method 800 that supports entity token segregation in accordance with aspects of the present disclosure. The operations of the method 800 may be implemented by a custodial token platform or its components as described herein. For example, the operations of the method 800 may be performed by a custodial token platform as described with reference to FIGS. 1 through 7. In some examples, a custodial token platform may execute a set of instructions to control the functional elements of the custodial token platform to perform the described functions. Additionally, or alternatively, the custodial token platform may perform aspects of the described functions using special-purpose hardware.

At 805, the method may include monitoring a plurality of actions by a first plurality of user profiles at a custodial token platform based at least in part on the first plurality of user profiles being associated with a first segregated entity for which a rebalancing rule is configured. The operations of 805 may be performed in accordance with examples as disclosed herein. In some examples, aspects of the operations of 805 may be performed by a monitoring user actions manager 625 as described with reference to FIG. 6.

At 810, the method may include determining, based at least in part on the rebalancing rule, a net change in token amounts attributed to the first plurality of user profiles associated with the first segregated entity during a first duration of time. The operations of 810 may be performed in accordance with examples as disclosed herein. In some examples, aspects of the operations of 810 may be performed by a net token amount manager 630 as described with reference to FIG. 6.

At 815, the method may include executing a transfer of a first amount of one or more crypto tokens between a first blockchain address associated with the first segregated entity and a second blockchain address associated with the custodial token platform, wherein the first amount is based at least in part on the rebalancing rule and the net change. The operations of 815 may be performed in accordance with examples as disclosed herein. In some examples, aspects of the operations of 815 may be performed by a transferring crypto tokens manager 635 as described with reference to FIG. 6.

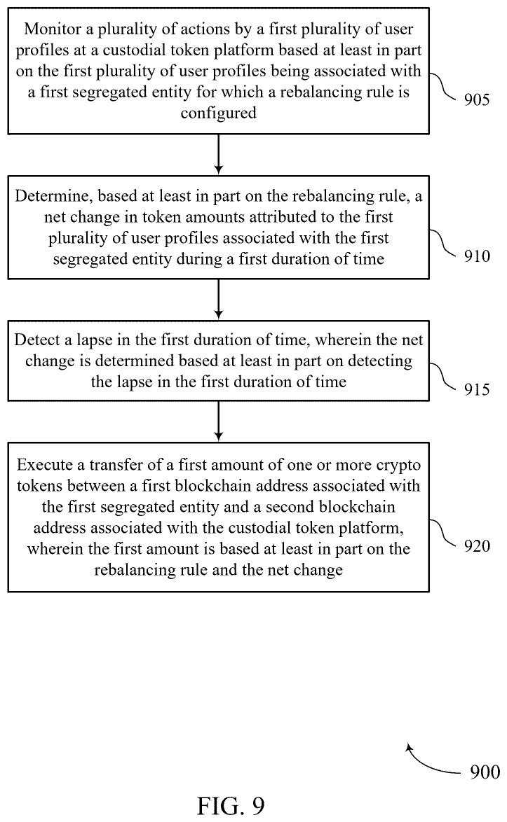

FIG. 9 shows a flowchart illustrating a method 900 that supports entity token segregation in accordance with aspects of the present disclosure. The operations of the method 900 may be implemented by a custodial token platform or its components as described herein. For example, the operations of the method 900 may be performed by a custodial token platform as described with reference to FIGS. 1 through 7. In some examples, a custodial token platform may execute a set of instructions to control the functional elements of the custodial token platform to perform the described functions. Additionally, or alternatively, the custodial token platform may perform aspects of the described functions using special-purpose hardware.

At 905, the method may include monitoring a plurality of actions by a first plurality of user profiles at a custodial token platform based at least in part on the first plurality of user profiles being associated with a first segregated entity for which a rebalancing rule is configured. The operations of 905 may be performed in accordance with examples as disclosed herein. In some examples, aspects of the operations of 905 may be performed by a monitoring user actions manager 625 as described with reference to FIG. 6.

At 910, the method may include determining, based at least in part on the rebalancing rule, a net change in token amounts attributed to the first plurality of user profiles associated with the first segregated entity during a first duration of time. The operations of 910 may be performed in accordance with examples as disclosed herein. In some examples, aspects of the operations of 910 may be performed by a net token amount manager 630 as described with reference to FIG. 6.

At 915, the method may include detecting a lapse in the first duration of time, wherein the net change is determined based at least in part on detecting the lapse in the first duration of time. The operations of 915 may be performed in accordance with examples as disclosed herein. In some examples, aspects of the operations of 915 may be performed by a monitoring time manager 640 as described with reference to FIG. 6.

At 920, the method may include executing a transfer of a first amount of one or more crypto tokens between a first blockchain address associated with the first segregated entity and a second blockchain address associated with the custodial token platform, wherein the first amount is based at least in part on the rebalancing rule and the net change. The operations of 920 may be performed in accordance with examples as disclosed herein. In some examples, aspects of the operations of 920 may be performed by a transferring crypto tokens manager 635 as described with reference to FIG. 6.

A method for segregating blockchain address actions by an apparatus is described. The method may include monitoring a plurality of actions by a first plurality of user profiles at a custodial token platform based at least in part on the first plurality of user profiles being associated with a first segregated entity for which a rebalancing rule is configured, determining, based at least in part on the rebalancing rule, a net change in token amounts attributed to the first plurality of user profiles associated with the first segregated entity during a first duration of time, and executing a transfer of a first amount of one or more crypto tokens between a first blockchain address associated with the first segregated entity and a second blockchain address associated with the custodial token platform, wherein the first amount is based at least in part on the rebalancing rule and the net change.

An apparatus for segregating blockchain address actions is described. The apparatus may include one or more memories storing processor executable code, and one or more processors coupled with the one or more memories. The one or more processors may individually or collectively be operable to execute the code to cause the apparatus to monitor a plurality of actions by a first plurality of user profiles at a custodial token platform based at least in part on the first plurality of user profiles being associated with a first segregated entity for which a rebalancing rule is configured, determine, based at least in part on the rebalancing rule, a net change in token amounts attributed to the first plurality of user profiles associated with the first segregated entity during a first duration of time, and execute a transfer of a first amount of one or more crypto tokens between a first blockchain address associated with the first segregated entity and a second blockchain address associated with the custodial token platform, wherein the first amount is based at least in part on the rebalancing rule and the net change.

Another apparatus for segregating blockchain address actions is described. The apparatus may include means for monitoring a plurality of actions by a first plurality of user profiles at a custodial token platform based at least in part on the first plurality of user profiles being associated with a first segregated entity for which a rebalancing rule is configured, means for determining, based at least in part on the rebalancing rule, a net change in token amounts attributed to the first plurality of user profiles associated with the first segregated entity during a first duration of time, and means for executing a transfer of a first amount of one or more crypto tokens between a first blockchain address associated with the first segregated entity and a second blockchain address associated with the custodial token platform, wherein the first amount is based at least in part on the rebalancing rule and the net change.

A non-transitory computer-readable medium storing code for segregating blockchain address actions is described. The code may include instructions executable by one or more processors to monitor a plurality of actions by a first plurality of user profiles at a custodial token platform based at least in part on the first plurality of user profiles being associated with a first segregated entity for which a rebalancing rule is configured, determine, based at least in part on the rebalancing rule, a net change in token amounts attributed to the first plurality of user profiles associated with the first segregated entity during a first duration of time, and execute a transfer of a first amount of one or more crypto tokens between a first blockchain address associated with the first segregated entity and a second blockchain address associated with the custodial token platform, wherein the first amount is based at least in part on the rebalancing rule and the net change.

In some examples of the method, apparatus, and non-transitory computer-readable medium described herein, the rebalancing rule specifies that a threshold percentage of an aggregated token amount attributed to the first plurality of user profiles associated with the first segregated entity may be held by the first blockchain address associated with the first segregated entity.

In some examples of the method, apparatus, and non-transitory computer-readable medium described herein, the rebalancing rule further specifies that a second aggregated token amount attributed to a second plurality of user profiles associated with a second segregated entity may be held by the second blockchain address that may be associated with the second segregated entity.

Some examples of the method, apparatus, and non-transitory computer-readable medium described herein may further include operations, features, means, or instructions for detecting a lapse in the first duration of time, wherein the net change may be determined based at least in part on detecting the lapse in the first duration of time.

In some examples of the method, apparatus, and non-transitory computer-readable medium described herein, the first segregated entity comprises an entity associated with a geographic location.

In some examples of the method, apparatus, and non-transitory computer-readable medium described herein, executing the transfer between the first blockchain address and the second blockchain address may include operations, features, means, or instructions for executing the transfer between the first blockchain address associated with one or more first private keys stored in a first offline environment and the second blockchain address that may be associated with one or more second private keys stored in a second offline environment.

In some examples of the method, apparatus, and non-transitory computer-readable medium described herein, executing the transfer between the first blockchain address and the second blockchain address may include operations, features, means, or instructions for executing a first transfer between the first blockchain address associated with one or more first private keys stored in a first offline environment and a third blockchain address associated with one or more third private keys stored in a first online environment and executing a second transfer between the third blockchain address and the second blockchain address that may be associated with one or more second private keys stored in a second offline environment.

In some examples of the method, apparatus, and non-transitory computer-readable medium described herein, determining the net change may include operations, features, means, or instructions for determining, using the plurality of actions, a respective net change for each crypto token of a plurality of crypto tokens supported by the custodial token platform and combining the respective net changes for the plurality of crypto tokens.

In some examples of the method, apparatus, and non-transitory computer-readable medium described herein, determining the net change may include operations, features, means, or instructions for combining amounts associated with one or more of a plurality of action types of the plurality of actions associated with the first plurality of user profiles.

In some examples of the method, apparatus, and non-transitory computer-readable medium described herein, the plurality of action types comprises buying, selling, sending, receiving, converting, withdrawing, staking, earning, layer two network messages, or any combination thereof.

Some examples of the method, apparatus, and non-transitory computer-readable medium described herein may further include operations, features, means, or instructions for determining whether respective amounts of a set of crypto tokens associated with the first plurality of user profiles may be less than one or more target thresholds associated with the first segregated entity and executing a second transfer of at least one of the set of crypto tokens.

Some examples of the method, apparatus, and non-transitory computer-readable medium described herein may further include operations, features, means, or instructions for determining that the second transfer results in an aggregated token amount attributed to the first plurality of user profiles being out of compliance with the rebalancing rule and executing a third transfer of at least one other crypto token of the set of crypto tokens between the first blockchain address and the second blockchain address.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for segregating blockchain address actions, comprising:
monitoring a plurality of actions by a first plurality of user profiles at a custodial token platform based at least in part on the first plurality of user profiles being associated with a first segregated entity for which a rebalancing rule is configured;
determining, based at least in part on the rebalancing rule, a net change in token amounts attributed to the first plurality of user profiles associated with the first segregated entity during a first duration of time; and
executing a transfer of a first amount of one or more crypto tokens between a first blockchain address associated with the first segregated entity and a second blockchain address associated with the custodial token platform, wherein the first amount is based at least in part on the rebalancing rule and the net change.

2. The method of claim 1, wherein the rebalancing rule specifies that a threshold percentage of an aggregated token amount attributed to the first plurality of user profiles associated with the first segregated entity is to be held by the first blockchain address associated with the first segregated entity.

3. The method of claim 2, wherein the rebalancing rule further specifies that a second aggregated token amount attributed to a second plurality of user profiles associated with a second segregated entity is to be held by the second blockchain address that is associated with the second segregated entity.

4. The method of claim 1, further comprising:
detecting a lapse in the first duration of time, wherein the net change is determined based at least in part on detecting the lapse in the first duration of time.

5. The method of claim 1, wherein the first segregated entity comprises an entity associated with a geographic location.

6. The method of claim 1, wherein executing the transfer between the first blockchain address and the second blockchain address comprises:
executing the transfer between the first blockchain address associated with one or more first private keys stored in a first offline environment and the second blockchain address that is associated with one or more second private keys stored in a second offline environment.

7. The method of claim 1, wherein executing the transfer between the first blockchain address and the second blockchain address comprises:
executing a first transfer between the first blockchain address associated with one or more first private keys stored in a first offline environment and a third blockchain address associated with one or more third private keys stored in a first online environment; and
executing a second transfer between the third blockchain address and the second blockchain address that is associated with one or more second private keys stored in a second offline environment.

8. The method of claim 1, wherein determining the net change further comprises:
determining, using the plurality of actions, a respective net change for each crypto token of a plurality of crypto tokens supported by the custodial token platform; and
combining the respective net changes for the plurality of crypto tokens.

9. The method of claim 1, wherein determining the net change further comprises:
combining amounts associated with one or more of a plurality of action types of the plurality of actions associated with the first plurality of user profiles.

10. The method of claim 9, wherein the plurality of action types comprises buying, selling, sending, receiving, converting, withdrawing, staking, earning, layer two network messages, or any combination thereof.

11. The method of claim 1, further comprising:
determining whether respective amounts of a set of crypto tokens associated with the first plurality of user profiles are less than one or more target thresholds associated with the first segregated entity; and
executing a second transfer of at least one of the set of crypto tokens.

12. The method of claim 11, further comprising:
determining that the second transfer results in an aggregated token amount attributed to the first plurality of user profiles being out of compliance with the rebalancing rule; and
executing a third transfer of at least one other crypto token of the set of crypto tokens between the first blockchain address and the second blockchain address.

13. An apparatus for segregating blockchain address actions, comprising:
one or more memories storing processor-executable code; and
one or more processors coupled with the one or more memories and individually or collectively operable to execute the code to cause the apparatus to:
monitor a plurality of actions by a first plurality of user profiles at a custodial token platform based at least in part on the first plurality of user profiles being associated with a first segregated entity for which a rebalancing rule is configured;
determine, based at least in part on the rebalancing rule, a net change in token amounts attributed to the first plurality of user profiles associated with the first segregated entity during a first duration of time; and
execute a transfer of a first amount of one or more crypto tokens between a first blockchain address associated with the first segregated entity and a second blockchain address associated with the custodial token platform, wherein the first amount is based at least in part on the rebalancing rule and the net change.

14. The apparatus of claim 13, wherein the rebalancing rule specifies that a threshold percentage of an aggregated token amount attributed to the first plurality of user profiles associated with the first segregated entity is to be held by the first blockchain address associated with the first segregated entity.

15. The apparatus of claim 14, wherein the rebalancing rule further specifies that a second aggregated token amount attributed to a second plurality of user profiles associated with a second segregated entity is to be held by the second blockchain address that is associated with the second segregated entity.

16. The apparatus of claim 13, wherein the one or more processors are individually or collectively further operable to execute the code to cause the apparatus to:
detect a lapse in the first duration of time, wherein the net change is determined based at least in part on detecting the lapse in the first duration of time.

17. The apparatus of claim 13, wherein the first segregated entity comprises an entity associated with a geographic location.

18. The apparatus of claim 13, wherein, to execute the transfer between the first blockchain address and the second blockchain address, the one or more processors are individually or collectively operable to execute the code to cause the apparatus to:
execute the transfer between the first blockchain address associated with one or more first private keys stored in a first offline environment and the second blockchain address that is associated with one or more second private keys stored in a second offline environment.

19. A non-transitory computer-readable medium storing code for segregating blockchain address actions, the code comprising instructions executable by one or more processors to:
monitor a plurality of actions by a first plurality of user profiles at a custodial token platform based at least in part on the first plurality of user profiles being associated with a first segregated entity for which a rebalancing rule is configured;
determine, based at least in part on the rebalancing rule, a net change in token amounts attributed to the first plurality of user profiles associated with the first segregated entity during a first duration of time; and
execute a transfer of a first amount of one or more crypto tokens between a first blockchain address associated with the first segregated entity and a second blockchain address associated with the custodial token platform, wherein the first amount is based at least in part on the rebalancing rule and the net change.

20. The non-transitory computer-readable medium of claim 19, wherein the instructions are further executable by the one or more processors to:
determine whether respective amounts of a set of crypto tokens associated with the first plurality of user profiles are less than one or more target thresholds associated with the first segregated entity; and
execute a second transfer of at least one of the set of crypto tokens.
